(19) United States
(12) Patent Application Publication
(10) Pub. No.: US 2016/0009057 A1
(43) Pub. Date: Jan. 14, 2016

(54) Heat Treatment Device for Use in a Hot Press to Transfer a Treatment Composition to a Substrate

(71) Applicant: Neenah Paper, Inc., Alpharetta, GA (US)

(72) Inventor: Russell Dolsey, Roswell, GA (US)

(21) Appl. No.: 14/326,558

(22) Filed: Jul. 9, 2014

(51) Int. Cl. B32B 25/20; B05D 3/10

(52) U.S. Cl. CPC B32B 25/20; B05D 3/10; B32B 2307/302

(57) ABSTRACT

Methods for treating a fibrous substrate are provided via positioning a treatment sheet adjacent to the fibrous substrate and positioning a heat treatment device onto the treatment sheet. The treatment sheet comprises a base sheet saturated with a treatment composition. The heat treatment sheet comprises a board formed and a flexible pad attached to the board, with the flexible pad comprises a conformable surface. Then, the method includes: pressing the board of the heat treatment device with the hot press member such that the conformable surface of the flexible pad presses onto the treatment sheet to transfer the treatment composition from the treatment sheet to the fibrous substrate using a wetting solution to carry the salt from the treatment sheet into the fibrous substrate; removing the heat treatment device and the treatment sheet from the fibrous substrate; and drying the fibrous substrate with the hot press member.

### BACKGROUND OF THE INVENTION

Images are often formed on a cloth garment (e.g., a shirt) via a heat transfer method or a direct-to-garment printing method. Depending on the cloth garment imaged, it is often desired to pre-treat the garment before forming the image. The pretreatment can help keep the ink on the surface of the garment and/or form a strong bond between the image and the garment.

For example, a treatment composition can be sprayed directly onto the garment. However, this spray method can apply the treatment composition unevenly across the surface area (and/or the thickness) of the garment. For instance, the treatment composition may be applied heavily in certain areas and lightly in other areas. Thus, due to the uneven application of the treatment composition to the garment, the depth that the ink penetrates the fibrous substrate across the cloth may be uneven, resulting in an image that will appear uneven. This unevenness is especially apparent when forming an image on a dark cloth using lighter colors (e.g., white).

Alternatively, the garment can be dipped and/or submerged into the treatment composition. However, this application results in the treatment composition being applied across the entire surface area of the garment. Thus, even the areas of the garment that are not going to be imaged (i.e., that will be free from an image) have the treatment composition present, resulting in wasted treatment composition.

U.S. Patent Publication No. 2013/0243961 of Dolsey, et al., which is incorporated by reference herein, teaches an improved method of pretreating a cloth garment prior to forming an image thereon. In use, the substrate (e.g., a t-shirt) is placed on a hot press and pressed for a relatively short time sufficient to remove any moisture from the substrate and to smooth the substrate's surface (e.g., 5-10 seconds). Then, the hot press is opened, and a treatment sheet containing the pretreatment treatment composition is placed on the substrate's surface, either as a wet treatment sheet already saturated with a wetting agent or dry treatment sheet. If dry, then a wetting solution is added to the treatment sheet.

The wet treatment sheet is then covered with a silicone pad to protect the treatment sheet and the substrate from heat and to even out the pressure from the hot press. The silicone pad is then pressed using a heat press for a time sufficient to transfer the treatment composition from the treatment sheet to the substrate. Then, the hot press is opened, and the silicone pad and the treatment sheet are removed. Finally, the hot press is closed directly on the treated substrate's surface (i.e., without the silicone pad or the treatment sheet present) to lock the treatment composition into the substrate.

However, the temperature of the silicone pad utilized in the process as a heat barrier rises during multiple pretreatment cycles, such as often encountered in a large-scale manufacturing process. Thus, the silicone pad's effectiveness as a heat barrier is reduced after a number of hot press cycles.

As such, a need exists for an improved process for accomplishing pretreatment of a substrate utilizing a hot press.

### BRIEF DESCRIPTION OF THE DRAWINGS

A full and enabling disclosure of the present invention, including the best mode thereof to one skilled in the art, is set forth more particularly in the remainder of the specification, which includes reference to the accompanying figures, in which:

FIG. 1 shows a top view of an exemplary heat treatment device;

FIG. 2 shows a cross-sectional view of the heat treatment device of FIG. 1;

FIGS. 3A-3D sequentially show use of the heat treatment device of FIG. 1 in use with a hot press to treat a substrate, with

FIG. 3A showing a cross-sectional view of an exemplary substrate being dried in a hot press,

FIG. 3B showing a cross-sectional view of an exemplary treatment sheet positioned on the dried substrate,

FIG. 3C shows the heat treatment device of FIGS. 1 and 2 positioned on the treatment sheet and within the hot press, and

FIG. 3D showing a cross-sectional view of the treated substrate being dried in the hot press; and

FIG. 4 shows a schematic diagram of an exemplary method utilizing the heat treatment device of FIG. 1.

Repeat use of reference characters in the present specification and drawings is intended to represent the same or analogous features or elements of the present invention.

### SUMMARY

Objects and advantages of the invention will be set forth in part in the following description, or may be obvious from the description, or may be learned through practice of the invention.

Methods are generally provided for treating a fibrous substrate prior to forming an image thereon. In one embodiment, the method comprising: positioning a treatment sheet adjacent to the fibrous substrate and positioning a heat treatment device onto the treatment sheet. Generally, the treatment sheet comprises a base sheet saturated with a treatment composition. The heat treatment sheet comprises a board formed and a flexible pad attached to the board, with the flexible pad comprises a conformable surface. Then, the method includes: pressing the board of the heat treatment device with the hot press member such that the conformable surface of the flexible pad presses onto the treatment sheet to transfer the treatment composition from the treatment sheet to the fibrous substrate using a wetting solution to carry the salt from the treatment sheet into the fibrous substrate; removing the heat treatment device and the treatment sheet from the fibrous substrate; and drying the fibrous substrate with the hot press member such that the salt remains in the substrate.

Heat treatment devices are also generally provided. In one embodiment, the heat treatment device comprises: a board formed from a material having a thermal conductivity of less than 0.1 W m⁻¹K⁻¹, wherein the board defines a first surface opposite from a second surface; and a flexible pad attached to the first surface of the board, wherein the flexible pad comprises a conformable surface.

Other features and aspects of the present invention are discussed in greater detail below.

### DEFINITIONS

As used herein, the term “printable” is meant to include enabling the placement of an image on a material, especially through the use of ink-jet inks.

In the present disclosure, when a layer is being described as “on” or “over” another layer or substrate, it is to be understood that the layers can either be directly contacting each other or have another layer or feature between the layers, unless otherwise stated. Thus, these terms are simply describing the relative position of the layers to each other and do not necessarily mean “on top of” since the relative position above or below depends upon the orientation of the device to the viewer.

As used herein, the term “thermal conductivity” refers to the property of a material to conduct heat. Thermal conductivity is defined as the amount of heat/energy (expressed in kcal, Btu or J) that is conducted in unit time through unit area of unit thickness of material, when there is a unit temperature difference. Thermal conductivity is expressed in the metric system in watt (W) m⁻¹°C⁻¹ or watts per meter per Kelvin (W m⁻¹K⁻¹). Thermal conductivity is also known as the k-value.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

I. Heat Treatment Device

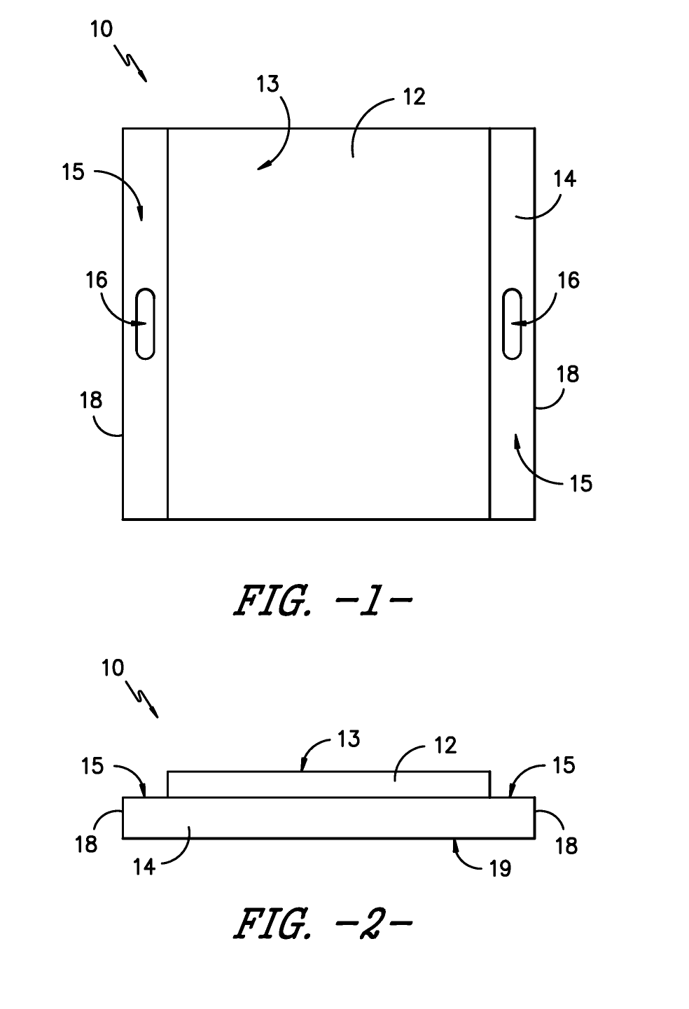

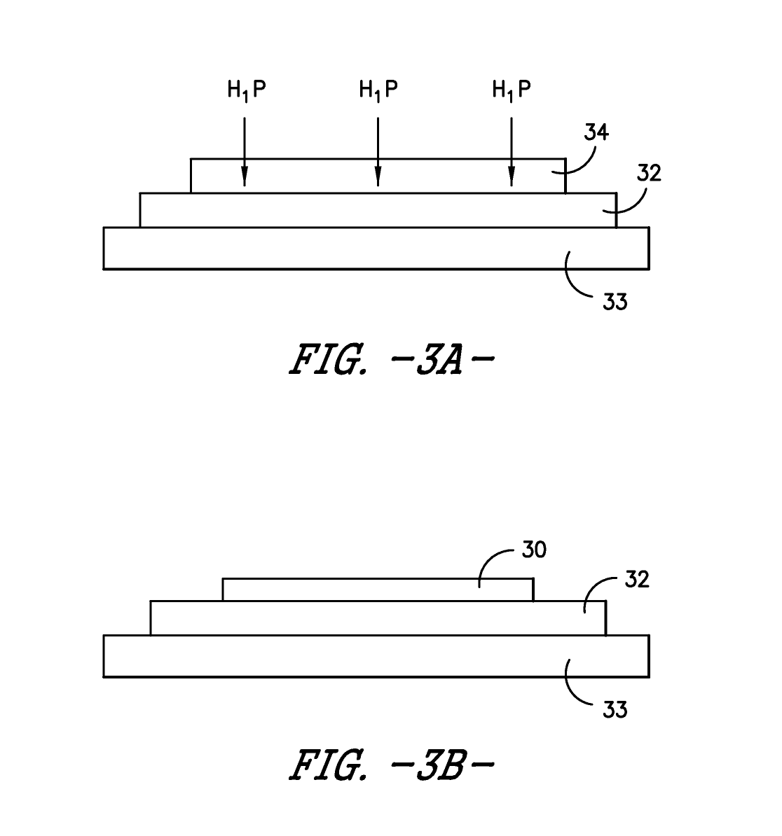

A heat treatment device is generally provided for use in a method of treating a fibrous substrate prior to forming an image thereon. FIGS. 1 and 2 show top and cross-sectional views, respectively, of an exemplary heat treatment device 10 that includes a flexible pad 12 attached to a board 14. As shown, the flexible pad 12 defines an exposed conformable surface 13 on one side, and is attached is attached on the opposite side to a first surface 15 of the board 14.

The flexible pad 12 can be any material that defines a conformable surface 13 thereon such the heat treatment device 10 applies substantially uniform pressure across the conformable surface 13 upon pressing. For example, the flexible pad 12 can be made of a rubber material, a silicon material, a polyurethane foam, a polystyrene foam, etc.

The thickness of the flexible pad 12 can be sufficient to provide conformable properties to the surface 13 and durability for repeated, multiple uses within a heat press, while remaining light enough for a user move the heat treatment device 10 by hand. For example, the flexible pad 12 can have a thickness of about 2 inches or less, such as about 0.125 inches to about 0.5 inches, although the thickness can vary depending on the type of material from which the flexible pad 12 is constructed.

The board 14 of the heat treatment device 10 of FIG. 1 defines lateral edges 18 on opposite sides of the first surface 15. In the embodiment shown, the flexible pad 12 is sized such that a portion of the first surface 15 of the board 14 remains exposed along each lateral edge 18. A handle aperture 16 is shown defined within the board 14 in each exposed area of the first surface 15 along each lateral edge 18. The board 14 of the heat treatment device 10 can be any material that has thermal barrier properties to inhibit thermal energy transfer through the heat treatment device 10 and sufficient stiffness such the heat treatment device 10 applies substantially uniform pressure across the conformable surface 13 upon pressing. However, the board 14 still has sufficient softness to aid the pad 12 in evening out the pressure applied to the treatment sheet and substrate in use.

In certain embodiments, the board 14 can have a thermal conductivity of less than 0.1 W m⁻¹K⁻¹ (e.g,. about 0.005 W m⁻¹K⁻¹ to about 0.05 W m⁻¹K⁻¹).

For example, the board 14 is, in one embodiment, a solid silicone rubber sheet that has a durometer hardness of 40 or less (e.g., a solid silicone rubber sheet sold as code COHR-400 and COHR-9040 by Rogers Corporation). Above a durometer hardness of 40, the pad behaves more like a rigid structure and its effectiveness is diminished for aiding the pad 12 in providing even pressure to the treatment sheet and substrate during use. In another embodiment, the board can be an open cell silicone foam sheet called BF-1000 (Rogers Corporation). These materials have the softness required to aid in leveling out the pressure on the pre-treat sheet, while remaining sufficiently stiff to provide structural support to the device 10.

In other embodiment, the board 14 is a rigid foam board formed from a non-heat absorbing material. For example, a ceramic fiber board can be utilized, such as the board sold under the trade name Fiberfrax® (Unifrax). Alternatively, a polyimide foam board can be utilized, such as the board sold under the trade name Solimide® (Professional Plastics). Both boards offer excellent heat and compression resistance.

In one particular embodiment, the board 14 can be a foam board, such as one having a relatively light weight (thereby easier to handle). Without wishing to be bound by any particular theory, it is believed that foam type boards, because of their many air spaces, would be the least likely to conduct heat through the board plus less likely to retain heat. Such foam the material for the board 14 has significant strength so that it can be picked up and handled repeated without breaking, while remaining light enough to handle by hand, thermally insulating, and soft enough to aid the pad 12 in evening out pressure applied to the board 14 to the underlying substrate. For example, the foam board can be constructed from rigid polystyrene, rigid fiberglass (e.g., CertainTeed® from CertainTeed Corporation), extruded polystyrene, expanded polystyrene, or expanded cord.

The thickness of the board 14 can be sufficient to provide structural strength to the heat treatment device 10 and durability for repeated, multiple uses within a heat press, while remaining light enough for a user move the heat treatment device 10 by hand. For example, the board 14 can have a thickness of about 2 inches or less, such as about 0.5 inches to about 1 inch, although the thickness can vary depending on the type of material from which the board 14 is constructed.

II. Transfer of Treatment Composition

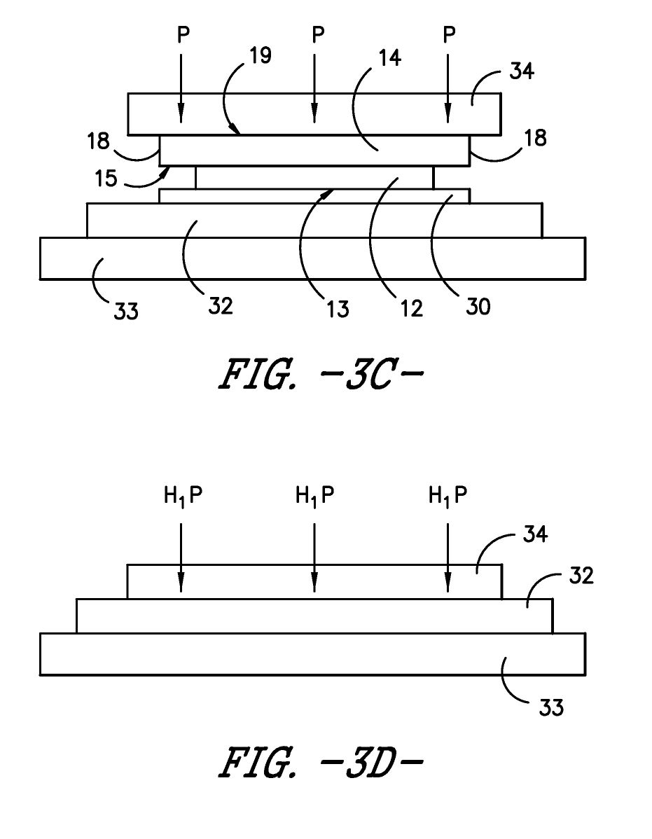

FIGS. 3A-3D sequentially show a cross-sectional view of the heat treatment device 10 of FIG. 1 in use, according to one exemplary method for treating a fibrous substrate 32 prior to forming an image thereon. In particular embodiments, the substrate 32 is a fibrous substrate, such as a woven fabric. For example, the substrate 32 can be a woven fabric of any suitable material for use in clothing garments (e.g., cotton, wool, nylon, polyester, or mixtures thereof). The presently disclosed methods are particularly suitable for forming an image on a dark colored fabric.

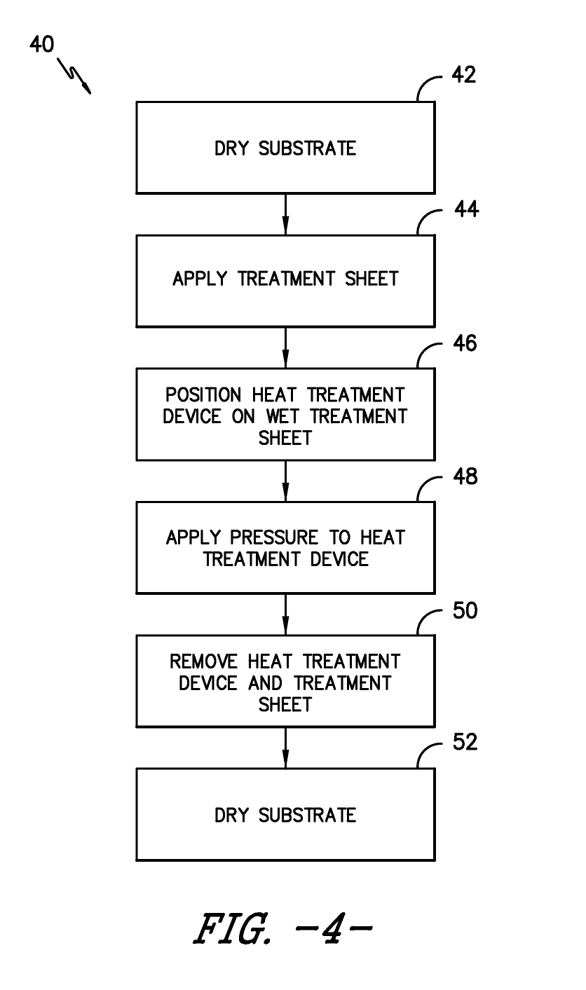

FIG. 4 shows an exemplary diagram of an exemplary method 40, which is sequentially depicted in FIGS. 3A-3D. This method uses the heat transfer device 10 to buffer the underlying substrate 32 from thermal energy transfer from the hot press member 34. First, the substrate is dried in step 42 of method 40. Referring to FIG. 3A, the substrate 32 (e.g., a fibrous substrate, such as a t-shirt) is placed on the press 33, and the hot press member 34 is pressed onto the substrate 32 and pressed for a relatively short time sufficient to remove any moisture from the substrate and to smooth the substrate's surface (e.g., 5-10 seconds). In certain embodiments, the drying step is performed with the hot press member 34 having a temperature of about 250° F. to about 385° F., such as about 300° F. to about 375° F. (e.g., about 350° F. to about 375° F.).

Then, the hot press member 34 is removed from the substrate 32, and a treatment sheet 30 containing the pretreatment treatment composition is placed on the substrate's surface in step 44 of FIG. 4. FIG. 3B shows a diagram of this positioning of the treatment sheet 30 on the substrate 32. The treatment sheet 30 can be positioned onto the substrate 32 either as a wet treatment sheet already saturated with a wetting agent or dry treatment sheet. If dry, then a wetting solution is added to the treatment sheet 30.

In step 46 of FIG. 4 and depicted in FIG. 3C, the heat treatment device 10 is then positioned onto the wet treatment sheet 30 such that the flexible pad is directly on the treatment sheet 30. The conformable surface 13 of the flexible pad 12 is pressed against treatment sheet 30 on a substrate 32 positioned on a press 33. A hot press member 34 is positioned on the second surface 19 of the board 14 (opposite from the flexible pad 12).

The hot press member 34 is then pressed onto the second surface 19 of the board 14, in step 48. The heat treatment device 10 serves to protect the treatment sheet 30 from any heat transfer from the hot press member 34, which may be still be hot due to the drying step 42 just performed (as shown in FIG. 3A). As such, transfer of a treatment composition from the treatment sheet 30 to the substrate 32 can be accomplished without significant thermal energy heat being applied and/or transferred to the treatment sheet 30 and/or the substrate 32. The temperature of the treatment sheet 30 can be no more than 100° C. during the transfer step 48, due to the thermal insulation properties of the heat treatment device 10. In one embodiment, the temperature of the treatment sheet 30 is about 20° C. to about 30° C. (e.g., about 20° C. to about 25° C.). This temperature of the treatment sheet 30 can be accomplished even as the temperature of the hot press member 34 may be about 100° C. or greater (e.g., about 100° C. to about 200° C.) due to the recent drying steps performed on the substrate 32 without sufficient time to cool the hot press member 34. Thus, the heat treatment device 10 can facilitate the method described herein in a continuous, large scale process.

In step 50, the hot press is opened, and the heat treatment device 10 and the treatment sheet 30 are removed from the surface of the substrate 32. Finally, the hot press member 34 is closed directly on the treated substrate's surface (i.e., without the heat treatment device 10 or the treatment sheet 30 present) in step 52, as shown in FIG. 3D. Heat and pressure are then applied to the substrate 32 to remove any transferred solvent (i.e., dry the substrate 32) and lock the treatment composition into the substrate 32. This second drying step 52 can be accomplished with the hot press member 34 having a temperature of about 250° F. to about 385° F., such as about 300° F. to about 375° F. (e.g., about 350° F. to about 375° F.). It is noted that in the second drying step (as with the first drying step), the lower the temperature of the hot press member 34, the longer the dwell time to dry the water off. At lower temperatures in the usefule range (e.g., around 300° F.), the time required for the press may be too long for a production environment (e.g., longer than 45 seconds). For a temperature of about 350° F., a drying time of about 35 to about 40 seconds may be required to dry a typical t-shirt fabric and a temperature of about 375° F. would require about 25 seconds to about 35 seconds. However, temperatures higher than 375° F. may lead to discoloring the fabric.

III. Treatment Sheets and Compositions

The treatment sheet 30 is utilized, along with the methods discussed above, to transfer a treatment composition to the substrate 32. For example, a treatment composition (e.g., a salt) can be transferred from the treatment sheet 30 into a fibrous substrate 32. According to particular embodiments of the presently disclosed methods, the treatment composition can be transferred so as to be present in and/or on the fibrous substrate in a substantially evenly distributed manner in the treated areas. In one embodiment, the treatment composition can be applied into and/or onto the substrate without the use of a spraying unit.

In certain embodiments, the application of the treatment composition can be controlled such that the treatment composition is applied to the areas where an image is to be formed (i.e., imaged areas) to form treated areas. For example, the treatment composition can be applied only to the areas where an image is to be formed (i.e., imaged areas), while leaving the other areas, corresponding to the areas of the substrate that remain unimaged, substantially free from the treatment composition. Thus, there can be treated areas on the garment (where the treatment composition has been transferred), and untreated areas on the garment that are substantially free from the treatment composition. According to one embodiment of the method, the treatment composition can be applied substantially evenly across the treated areas.

The treatment composition transferred to the substrate to form the treated areas can, in one particular embodiment, include a salt. For example, the salt can be calcium chloride, calcium nitrate, magnesium chloride, or a mixture thereof. The amount of salt that can be applied may be varied as desired based on the particular fibrous substrate treated, but will generally be in an amount sufficient to keep a majority of the colorant of the image near the surface of the substrate. For example, at least 50% of the colorant (e.g., dye, pigment, etc.) of the image can penetrate less than about 25% of the thickness of the fibrous substrate. Without wishing to be bound by any particular theory, it is believed that the salt component of the treatment composition (which is present within the thickness of the fibrous substrate) can draw the ink solvent quickly into the interior of the fibrous substrate causing the colorant material of the ink to remain on or near the surface of the substrate. Thus, the colorant material of the ink can be quickly dried to remain on or near the surface of the substrate. This advantage is particularly suitable for direct-to-garment printing on the treated areas.

While the treatment composition may include only a salt or a mixture of salts (e.g., being substantially free from any other material), other materials may also be included in the treatment composition. For example, an acrylic binder may also be included in the treatment composition to help bond the colorant of the image to the fibrous substrate. For example, a non-ionic and/or cationic acrylic binder can be included in the treatment composition. Suitable polyacrylic binders can include polymethacrylates, poly(acrylic acid), poly(methacrylic acid), and copolymers of the various acrylate and methacrylate esters and the free acids; ethylene-acrylate copolymers; vinyl acetate-acrylate copolymers, and the like. Suitable acrylic polymers that can be utilized as a binder in the treatment composition include those acrylic latexes sold under the trade names Rhoplex by Rohm and Haas (Wilmington, Del.) and/or HYCAR® by Lubrizol, Inc. (Cleveland, Ohio). Other cationic additives may be employed, such as APC-M1 from Ghen Materials, a tertiary amine salt of MDAA (methyl diallylamine) and Glascol F207 from CIBA Specialty Chemicals, and APC-A1, which are examples of a quarternary ammonium salt of DADMAC (dimethyl diallylammonium chloride).

The treatment composition is applied utilizing a treatment sheet 30. In one embodiment, the treatment sheet 30 can include a base sheet saturated with a salt. The base sheet can include pulp fibers, such as those suitable for paper making, to form a fibrous web. The fibrous web including pulp fibers can be in the form of a paper web, a spunbond web of synthetic fibers (e.g., polyethylene, polypropylene, or copolymers thereof, or a mixture thereof) that has been hydroentangled with pulp fibers.

The base sheet can be saturated with a solution containing the treatment composition (e.g., a salt), such that the treatment composition is intermixed with the fibers of the web, and contained within the construction of the web. In one embodiment, the treatment sheet can be dried, to remove the solvent of the solution while leaving the salt therein.

No matter the method utilized, the substrate can be imaged onto the treated areas. The image can be formed on the substrate 32 by any suitable method. For example, the image can be formed via direct-to-garment printing. Alternatively, the image can be formed via a heat transfer method, such as disclosed in U.S. Pat. No. 7,604,856 of Kronzer, et al., U.S. Pat. No. 7,364,636 of Kronzer, U.S. Pat. No. 7,361,247 of Kronzer, U.S. Pat. No. 6,916,751 of Kronzer, U.S. Pat. No. 6,200,668 of Kronzer, U.S. Pat. No. 5,716,900 of Kronzer, et al., all of which are incorporated by reference herein.

With reference to each of the following embodiments, the wetting solution can be an aqueous solution that includes water. For example, the wetting solution can be substantially water (i.e., deionized water, tap water, etc.) without a significant amount of any other solvent present. In other embodiments, the wetting solution can include, either substantially alone or in addition to water, an alcohol (e.g., methanol, ethanol, propanol, isopropanol, butanol, etc.), a glycol, an acetate (e.g., ethyl acetate, acetone, etc.), etc., or mixtures thereof.

In one particular embodiment, a treatment sheet 30 that is substantially dry (i.e., free from any liquid, such as a wetting solution) can be utilized to transfer a treatment composition to the substrate 32. For instance, the fibrous substrate can be treated prior to forming an image thereon, according to the following method: positioning a dry treatment sheet (e.g,. a paper web saturated with a salt) adjacent to the fibrous substrate; thereafter, wetting a backside of the dried treatment sheet with a wetting solution (e.g., via spraying, a sponge, or application of a wet sheet adjacent thereto); pressing the backside of the treatment sheet such that the wetting solution carries the salt from the treatment sheet to the fibrous substrate; and drying the fibrous substrate such that the salt remains in the substrate. For example, the treatment sheet 30 can be positioned adjacent to the substrate 32 while substantially dry. Then, wet sheet (not shown) can then be applied onto the dry treatment sheet 30 that is positioned opposite from the substrate 32. The wet sheet can be any suitable sheet (e.g., a paper web) that includes a sufficient amount of the wetting solution.

Alternatively, the treatment sheet 30 can be substantially saturated with the wetting solution (such as discussed above) prior to positioned adjacent to the substrate 32 in order to transfer a treatment composition to the substrate. For instance, the fibrous substrate can be treated prior to forming an image thereon, according to the following method: positioning a wet treatment sheet adjacent to the fibrous substrate, wherein the wet treatment sheet comprises a paper web saturated with a treatment composition (e.g., a salt solution); pressing a backside of the treatment sheet such that the wetting solution carries the salt from the treatment sheet to the fibrous substrate; and drying the fibrous substrate such that the salt remains in the substrate.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims

What is claimed:

1. A method of treating a fibrous substrate prior to forming an image thereon, the method comprising:
positioning a treatment sheet adjacent to the fibrous substrate, wherein the treatment sheet comprises a base sheet saturated with a treatment composition;
positioning a heat treatment device onto the treatment sheet, wherein the heat treatment sheet comprises a board formed and a flexible pad attached to the board, wherein the flexible pad comprises a conformable surface;
pressing the board of the heat treatment device with the hot press member such that the conformable surface of the flexible pad presses onto the treatment sheet to transfer the treatment composition from the treatment sheet to the fibrous substrate using a wetting solution to carry the salt from the treatment sheet into the fibrous substrate;
removing the heat treatment device and the treatment sheet from the fibrous substrate; and
drying the fibrous substrate with the hot press member such that the salt remains in the substrate.

2. The method as in claim 1, wherein the flexible pad comprises a rubber material.

3. The method as in claim 1, wherein the flexible pad comprises a silicone material.

4. The method as in claim 1, wherein the temperature of the treatment sheet during transfer of the treatment composition to the substrate is no more no more than 100° C.

5. The method as in claim 1, wherein the temperature of the treatment sheet during transfer of the treatment composition to the substrate is about 20° C. to about 30° C.

6. The method as in claim 1, wherein the temperature of the hot press member during during transfer of the treatment composition to the substrate is about 100° C. or greater.

7. The method as in claim 1, further comprising:
prior to positioning a treatment sheet adjacent to the fibrous substrate, drying the fibrous substrate utilizing a hot press member.

8. The method as in claim 1, wherein the treatment composition comprises a salt.

9. The method as in claim 8, wherein the salt comprises calcium chloride, calcium nitrate, magnesium chloride, or a mixture thereof.

10. The method as in claim 1, wherein the treatment sheet is saturated with a wetting agent and the treatment composition when positioned adjacent to the fibrous substrate.

11. A heat treatment device, comprising:
a board formed from a material having a thermal conductivity of less than 0.1 W m⁻¹K⁻¹, wherein the board defines a first surface opposite from a second surface; and
a flexible pad attached to the first surface of the board, wherein the flexible pad comprises a conformable surface.

12. The heat treatment device as in claim 11, wherein the flexible pad comprises a rubber material.

13. The heat treatment device as in claim 11, wherein the flexible pad comprises a silicone material.

14. The heat treatment device as in claim 11, wherein the flexible pad has a thickness of about 0.125 inches to about 0.5 inches.

15. The heat treatment device as in claim 11, wherein the board defines lateral edges on opposite sides of the first surface, and wherein the flexible pad is sized such that a portion of the first surface remains exposed along each lateral edge.

16. The heat treatment device as in claim 15, wherein a handle aperture is defined within the board in each exposed area of the first surface.

17. The heat treatment device as in claim 11, wherein the board has a thermal conductivity that is about 0.005 W m⁻¹K⁻¹ to about 0.05 W m⁻¹K⁻¹.

18. The heat treatment device as in claim 11, wherein the board has a thickness of about 0.5 inches to about 1 inch.
